(19) United States
(12) Patent Application Publication
(10) Pub. No.: US 2005/0102793 A1
(43) Pub. Date: May 19, 2005

(54) Hand tool holder

(76) Inventor: Leo Shih, Taichung (TW)

Correspondence Address: LAW OFFICE OF LIAUH & ASSOC., 4224 WAIALAE AVE, STE 5-388, HONOLULU, HI, 96816, US

(21) Appl. No.: 10/717,948

(22) Filed: Nov. 19, 2003

(51) Int. Cl. E05D 15/00

(52) U.S. Cl. 16/96 R; 16/87 R

(57) ABSTRACT

A hand tool holder comprises a base and a plurality of seats. The base is provided with a slide slot. The seats are provided with a slide block and a retaining portion. The seats are slidably mounted on the base such that the slide block of the seats is slidably received in the slide slot of the base. The retaining portion of the seats is intended to retain separably the hand tool.

### FIELD OF THE INVENTION

The present invention relates to a framework for holding a hand tool or component parts of the hand tool.

### BACKGROUND OF THE INVENTION

As shown in FIG. 1, a prior art tool holder 2 is used to hold a variety of screwdriver tips 1.

As shown in FIG. 2, a prior art tool holder 4 is used to hold a plurality of wrenches various in specification.

As shown in FIG. 3, a prior art tool holder 6 is used to hold a plurality of sockets 5.

As shown in FIG. 4, a prior art tool holder 7 is provided with a plurality of retaining pieces 8 for retaining a plurality of sockets 5 various in specification.

The prior art tool holdes described above are limited in purpose in that they are used exclusively to hold a specific kind of hand tool. In another words, the prior art tool holders can not be used interchangeably.

### SUMMARY OF THE INVENTION

The primary objective of the present invention is to provide a versatile hand tool holder free of the shortcomings of the prior art tool holders described above.

In keeping with the principle of the present invention, the foregoing objective of the present invention is attained by a hand tool holder comprising a base and a plurality of seats mounted slidably on the base. The seats are provided with a retaining portion for retaining removably a hand tool or a component part of the hand tool. The retaining portion is provided with a means to prevent the hand tool or the component part of the hand tool from being disengaged with the seats. The seats are provided with an identification portion for marking the specification of a hand tool.

The features and the advantages of the present invention will be more readily understood upon a thoughtful deliberation of the following detailed description of a preferred embodiment of the present invention with reference to the accompanying drawings.

### BRIEF DESCRIPTION OF THE DRAWINGS

FIG. 1 shows a schematic view of a prior art tool holder for holding screwdriver tips.

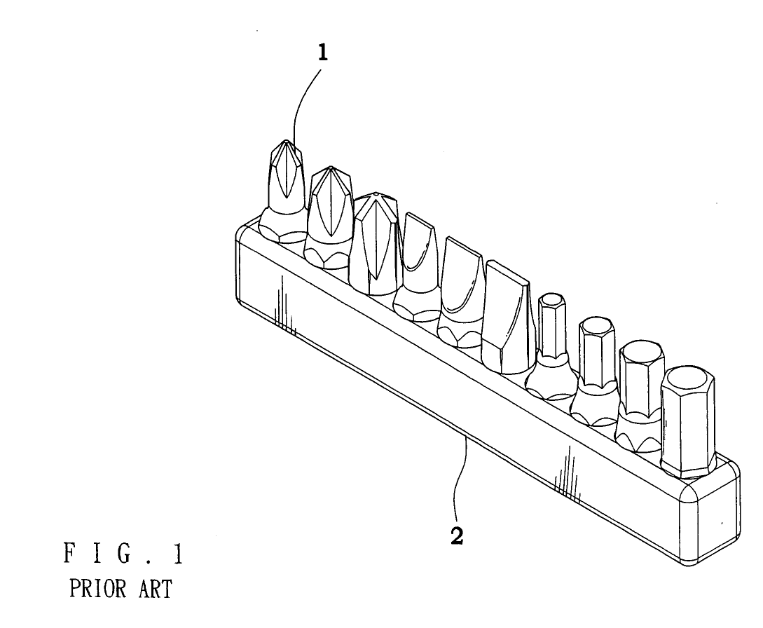

FIG. 2 shows a schematic view of a prior art tool holder for holding wrenches.

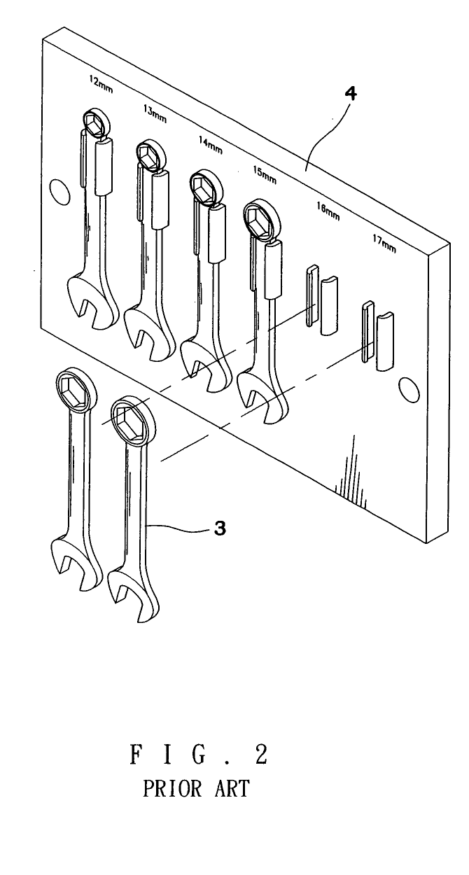

FIG. 3 shows a schematic view of a prior art tool holder for holding sockets of a socket wrench.

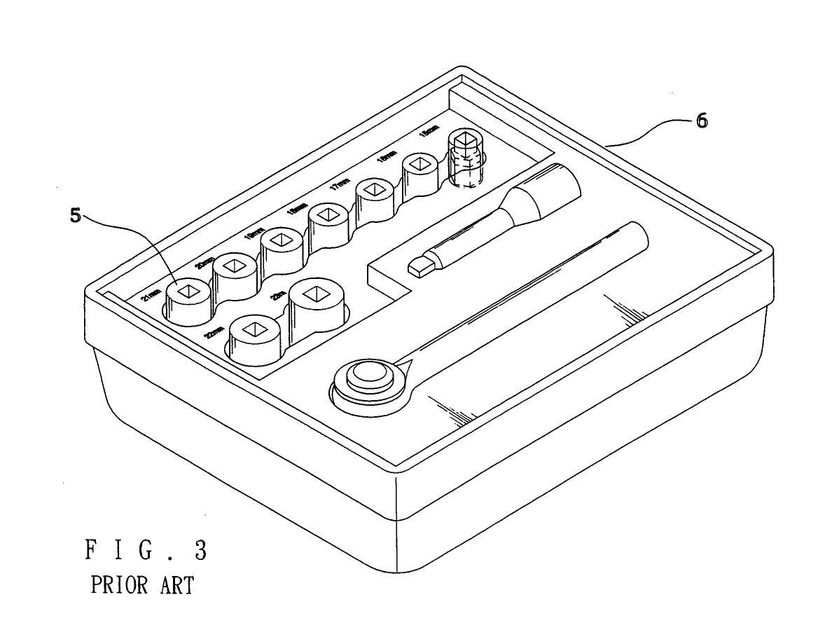

FIG. 4 shows a schematic view of a prior art tool holder for holding sockets of various specifications.

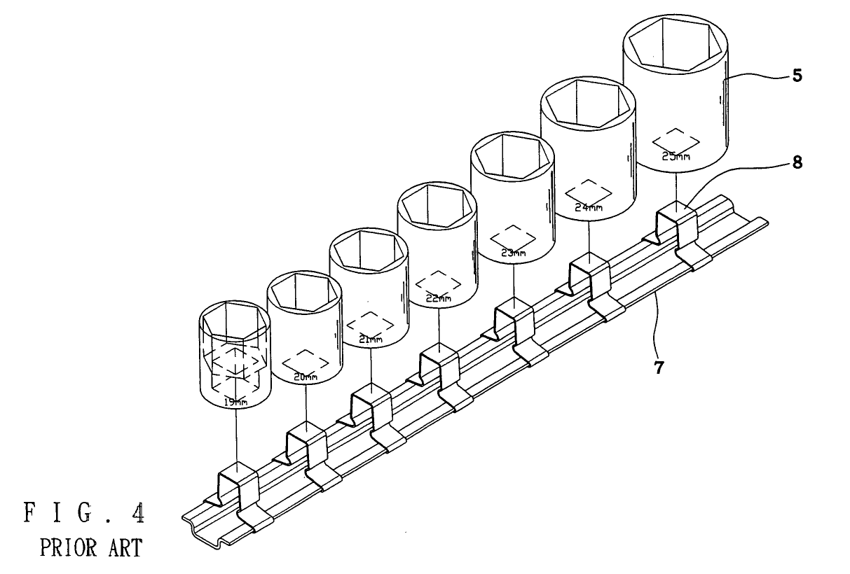

FIG. 5 shows a schematic view of the preferred embodiment of the present invention adapted to hold a plurality of sockets of various specifications.

FIG. 6 shows a schematic view of the preferred embodiment of the present invention adapted to hold a plurality of wrenches of various specifications.

FIG. 7 shows a schematic view of the preferred embodiment of the present invention adapted to hold a plurality of screwdriver tips of various specifications.

FIG. 8 shows a schematic view of the preferred embodiment of the present invention adapted to hold a plurality of hand tools of various types and specifications.

### DETAILED DESCRIPTION OF THE PREFERRED EMBODIMENT

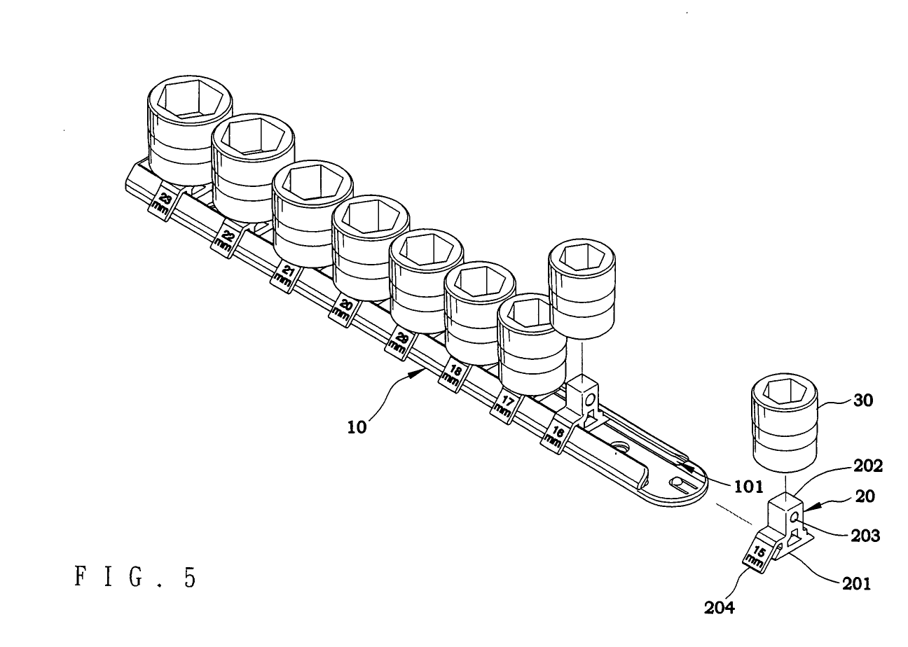

As shown in FIG. 5, a hand tool holder embodied in the present invention comprises a base 10, and a plurality of seats 20 slidably mounted on the base 10. The seats 20 are intended to retain removably a plurality of sockets 30 of a socket wrench. The base 10 is provided in an upper side with a slide slot 101 extending from one longitudinal end through other longitudinal end of the base 10. The seats 20 are provided at the bottom with a slide block 201, and at the top with a retaining portion 202 which is in turn provided with a retaining ball 203 urged by a spring (not shown in the drawing). The seats 20 are further provided with an identification portion 204 on which a specification is vividly marked such that the specification is corresponding to that of a specific socket 30. The seats 20 are slidably mounted on the base 10 such that the slide block 201 of the seats 20 is slidably received in the slide slot 101 of the base 10.

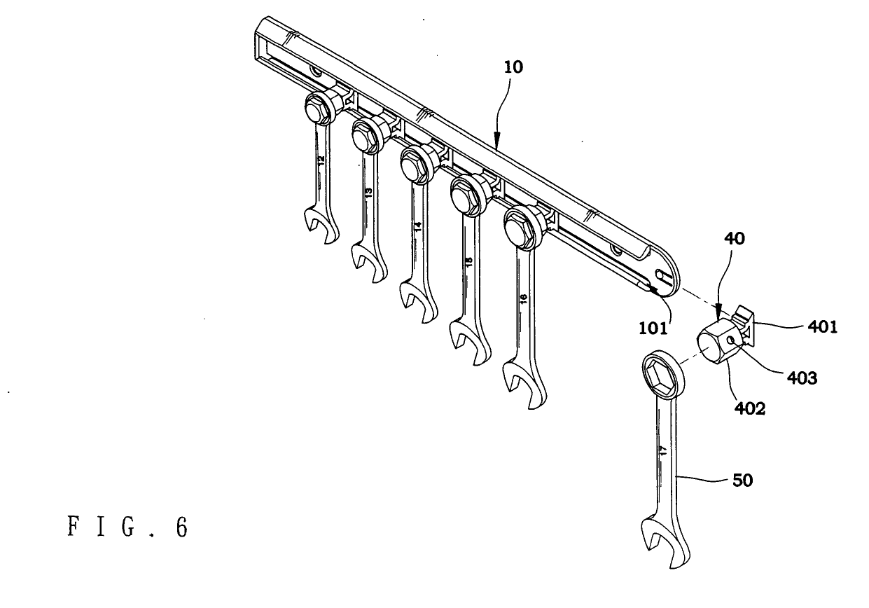

As shown in FIG. 6, the base 10 of the present invention is compatible with a plurality of seats 40, each having a slide block 401, a retaining portion 402, and a retaining ball 403 urged by a spring (not shown in the drawing). The retaining portion 402 is dimensioned to fit into the box end of a double-ended wrench 50.

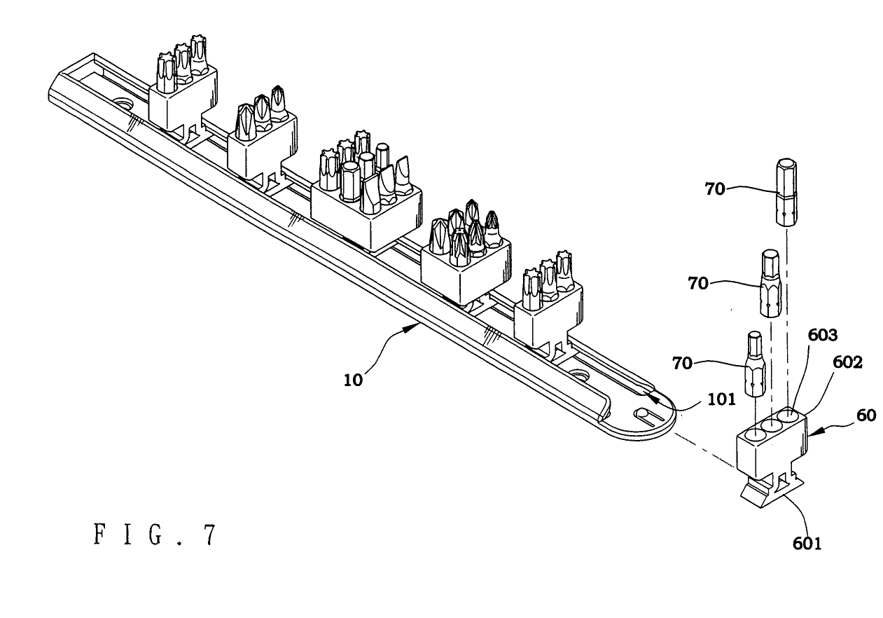

As shown in FIG. 7, the base 10 of the present invention is compatible with a plurality of seats 60, each having a slide block 601 and a retaining portion 602. The retaining portion 602 is provided with a plurality of slots 603 for holding a plurality of screwdriver tips 70. The seats 60 are slidably mounted on the base 10 such that the slide block 601 is slidably received in the slide slot 101 of the base 10.

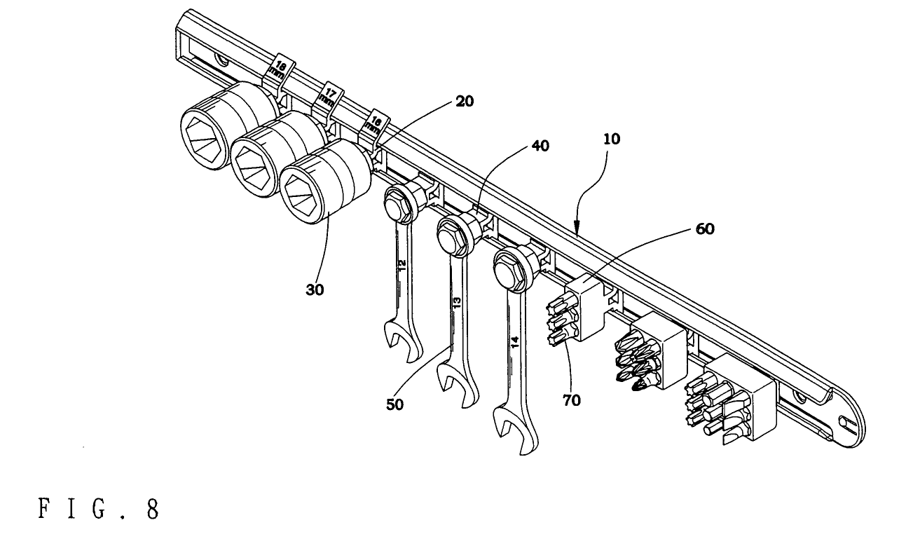

As shown in FIG. 8, a plurality of sockets 30, double-ended wrenches 50, and screwdriver tips 70 are concurrently held by the base 10 of the tool holder of the present invention.

The embodiment of the present invention described above is to be regarded in all respects as being illustrative and nonrestrictive. Accordingly, the present invention may be embodied in other specific forms without deviating from the spirit thereof. The present invention is therefore to be limited only by the scopes of the following claims.

1. A hand tool holder comprising:
a base provided in an upper side with a slide slot; and
a plurality of seats, each being provided with a slide block and a retaining portion for retaining removably a tool whereby said seats are slidably mounted on said base such that said slide block of said seats is slidably received in said slide slot of said base.

2. The hand tool holder as defined in claim 1, wherein said retaining portion is provided with a retaining ball and a spring urging said retaining ball.

3. The hand tool holder as defined in claim 1, wherein said seats are provided with an identification portion for marking a specification of the tool.

4. The hand tool holder as defined in claim 1, wherein said retaining portion of said seats is provided in a top thereof with one or more slots for receiving a plurality of component parts of a hand tool.
